(19) United States
(12) Patent Application Publication
(10) Pub. No.: US 2016/0174676 A1
(43) Pub. Date: Jun. 23, 2016

(54) Bag Attachment Apparatus and Bag Therefor

(71) Applicant: Vaughn Berry, Post Falls, ID (US)

(72) Inventor: Vaughn Berry, Post Falls, ID (US)

(21) Appl. No.: 14/577,788

(22) Filed: Dec. 19, 2014

(51) Int. Cl. A45C 11/24; A45C 7/00; A45C 3/00; F16M 13/02; A45C 13/00

(52) U.S. Cl. CPC A45C 11/24; F16M 13/02; A45C 13/002; A45C 3/001; A45C 7/0059; A45C 2003/007

(57) ABSTRACT

An apparatus including a base, a bag attachment portion, and an anchor member. The base extends at least partially in a plane. A direction of the thickness of the base extends in a direction orthogonal to the plane. The base includes an opening through the thickness thereof, such that the base is securable to a surface of an object via the opening. The bag attachment portion extends from the base portion. The anchor member is disposed on the bag attachment portion. The anchor member is configured to anchor a removable bag to the bag attachment portion when the base is secured to the object. At least one of the bag attachment portion or a portion of the anchor member extends in a direction transverse to the plane in which the base at least partially extends.

### BACKGROUND

When performing recreational activities, it may be desirable to carry with oneself items such as a wallet, purse, keys, phone, etc. for convenience, security, safety, or other purposes. In some instances of recreation, the nature of the activity naturally lends itself to easily and conveniently carrying these items on one's body or with the devices of the activity. For example, it may be easy and convenient to carry a wallet, camera, and keys either in a golf bag or in a mobile cart as a player plays golf on a course. It may be less convenient, however, to carry personal items while performing many other recreational activities.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates items that may be similar or identical.

FIG. 1A illustrates an isometric view of a bracket and shims according to an exemplary embodiment of the application.

FIG. 1B illustrates an isometric view of a portion of an alternative bracket according to another exemplary embodiment of the application.

FIG. 2A illustrates an isometric front view of a bag according to an exemplary embodiment of the application.

FIG. 2B illustrates a rear view of a bag according to the exemplary embodiment of the application depicted in FIG. 2A.

FIG. 3 illustrates an isometric view of a bag attached to a bracket on a surface of a recreational device according to an exemplary embodiment of the application.

FIG. 4A illustrates a top view of a bag attached to a bracket on a surface of a recreational device, showing shims in one position, according to an exemplary embodiment of the application.

FIG. 4B illustrates a top view of a bag attached to a bracket on a surface of a recreational device, showing shims in another position, according to an exemplary embodiment of the application.

FIG. 5 illustrates a side view of a bag attached to a bracket on a surface of a snowboard with the snowboard binding attached according to an exemplary embodiment of the application.

FIG. 6A illustrates a top view of an alternative bracket according to an exemplary embodiment of the instant application.

FIG. 6B illustrates a side profile view of the bracket of FIG. 6A according to an exemplary embodiment of the instant application.

FIG. 6C illustrates another side profile view of the bracket of FIG. 6A according to an alternative exemplary embodiment of the instant application.

FIGS. 6D-6F illustrate the bag attachment portion of a bracket according to alternative exemplary embodiments of the instant application.

FIGS. 7A-7E illustrate the bag according to alternative exemplary embodiments of the instant application.

### DETAILED DESCRIPTION

### Overview

In view of the desire to keep one's personal belongings with the person, whether for safekeeping or other reasons, a convenient and practical means of achieving this goal is described with respect to the figures as follows.

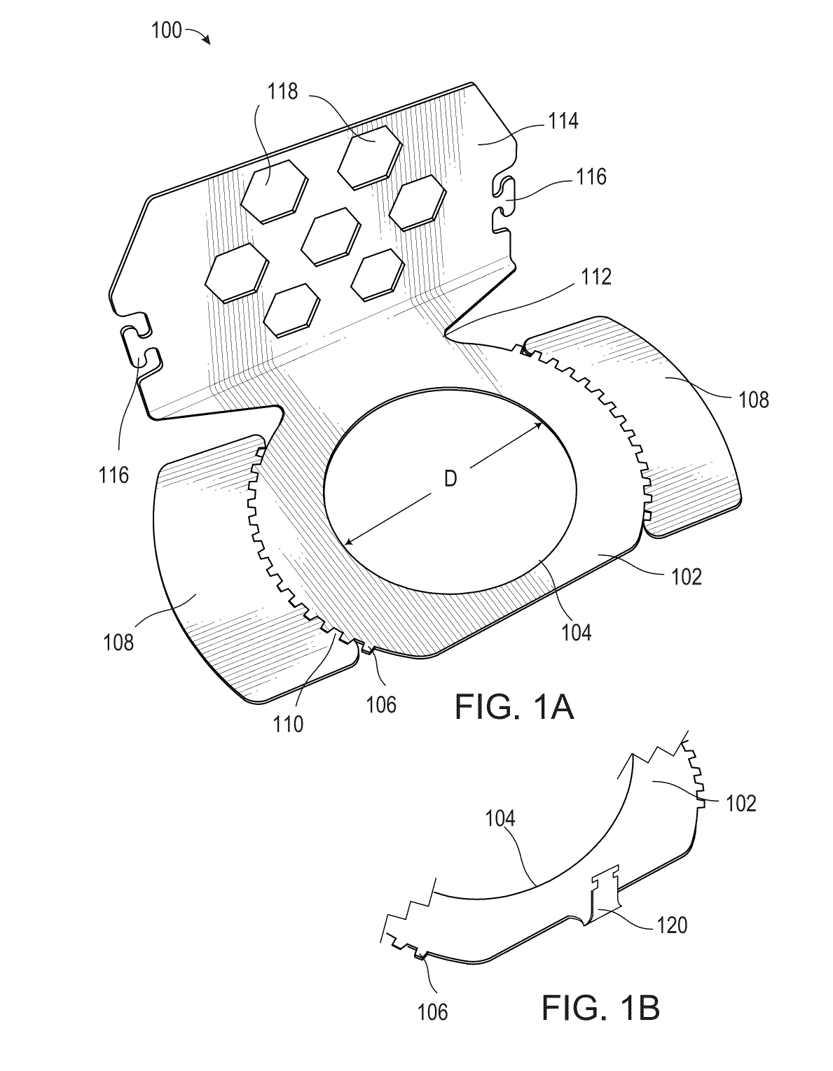

FIG. 1A depicts a bag attachment apparatus 100, (generally referred to as a bracket herein). The bracket 100 may be used to secure a bag (not shown in FIG. 1A) to the surface of a recreational device, such as, for example, a snowboard, a paddle board, a long board, a surfboard, a rack on a bicycle, a kayak, a snowmobile, a motorcycle, a quad, or any other compatible recreational device. Inasmuch as users of the above types of recreational devices may periodically need to dismount from the devices for any number of reasons, whether for long or short periods of time, users may desire to remove the bag temporarily or long term for safekeeping or other purposes. As such, it may be desirable to removably attach the bag to the bracket 100 via a means by which the bag can be quickly released. The instant application provides for this capability, which is discussed further herein below.

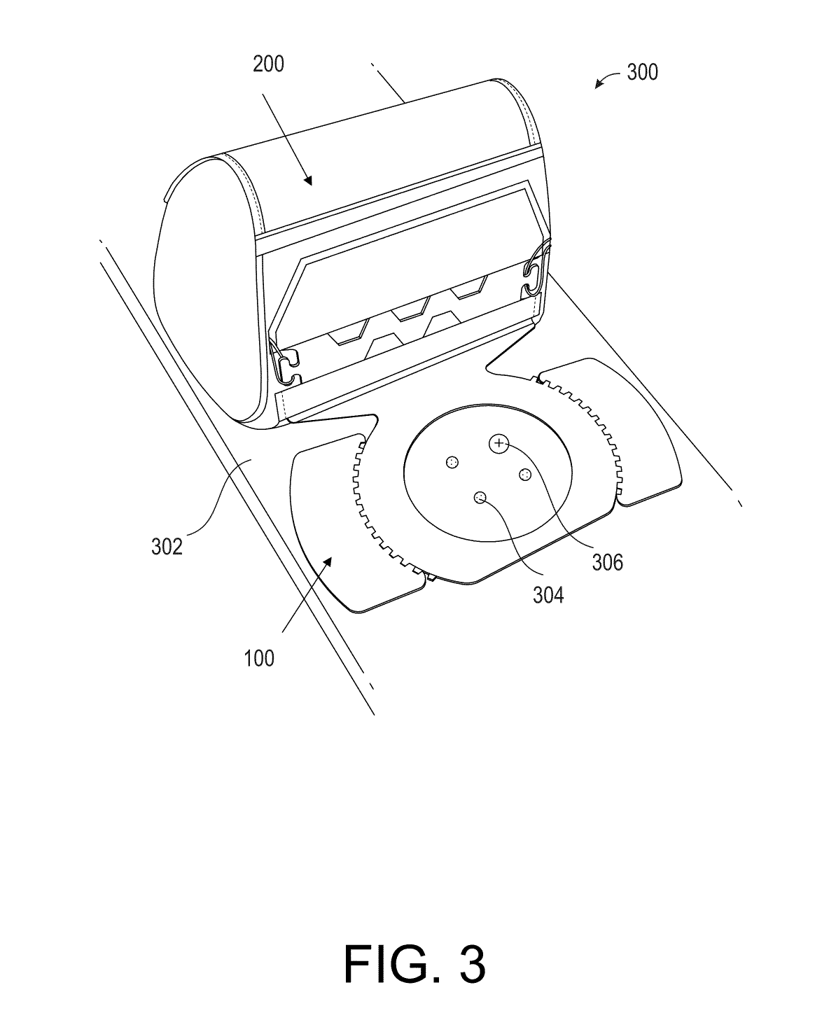

Additionally, in view of the large number of possible recreational devices on which a user may desire to easily and unobtrusively carry their belongings, it may also be desirable that the bracket 100 itself be removable so as to transfer the bag and the bracket 100 between devices according to the users' preferences or seasons. For example, a user may desire to carry a bag on a snowboard in the winter, and then on a paddle board or long board during the spring or summer when the winter season is over. As such, the bracket 100 may include a base portion 102 that abuts the surface of the recreational device, (which may also be referred to herein as simply the base, the base plate, or the base portion of a plate). The bracket 100 may be attached to the surface of the recreational device via fastening hardware (see FIG. 3) that is specific to the device. The hardware may secure the bracket 100 against the surface of the device by passing through a through hole 104 in the base 102 and attaching to the device, thereby holding down the base 102 of the bracket 100.

In an embodiment shown in FIG. 1A, the through hole 104 has a diameter D. Through hole 104 having a diameter D may accommodate, for example, a binding disc (not shown) from a snowboard binding. In this manner, the bracket 100 is adaptable to many different existing devices, and it may not be necessary to make significant alterations to those devices, nor would it be necessary to purchase specifically designed components for specific devices that, while possibly attaining a similar function, require substantially higher costs. For example, it is possible that a specific binding for a snowboard may be designed to carry a bag via a component on the binding. However, a binding itself is far more expensive than it would be to simply obtain a device as described herein, which is easily attachable without requiring a new binding as the described device may be retrofitted onto the existing devices (snowboards for example). Thus, a user may remove the bracket 100 as desired and place it on any other desired compatible device by securing the base 102 to the device.

In another embodiment (not shown), instead of having the through hole 104 in the base 102, the base of the bracket may not be a complete circle, so as to have an opening through a side thereof directly to the center of the base. Depending on the type and location of the hardware fasteners, the opening may allow a user to slide the bracket, if desired, into position under pre-installed hardware fasteners, without needing to completely remove the hardware fasteners. Alternatively, specific fastening hardware may not be necessary, and instead, the hardware for fastening the base to the surface of the object may include an adhesive.

Although the bracket 100 may be removed, for example, to change the device on which it is used, there is a greater likelihood that the bag would more frequently be attached and detached for safekeeping of the user's belongings. Thus, to the extent that the bag may be removably attached, the bracket 100 may include a bag attachment portion 114. Bag attachment portion 114 may be connected to base 102, and may extend away from base 102. In an embodiment shown in FIG. 1A, the bag attachment portion 114 may extend transversely to the direction of the extension of base 102. Further, bag attachment portion 114 may be part of an integral piece of material from which an entirety of the base 102 and the bag attachment portion 114 are formed. That is, as depicted, base 102 and bag attachment portion 114 may be formed as a unitary piece of material, and bag attachment portion 114 may be simply bent at joint 112 in a direction transverse to the base 102. It is contemplated, however, that bag attachment portion 114 may be separately fabricated and then attached to base 102 at joint 112 via any suitable attachment means.

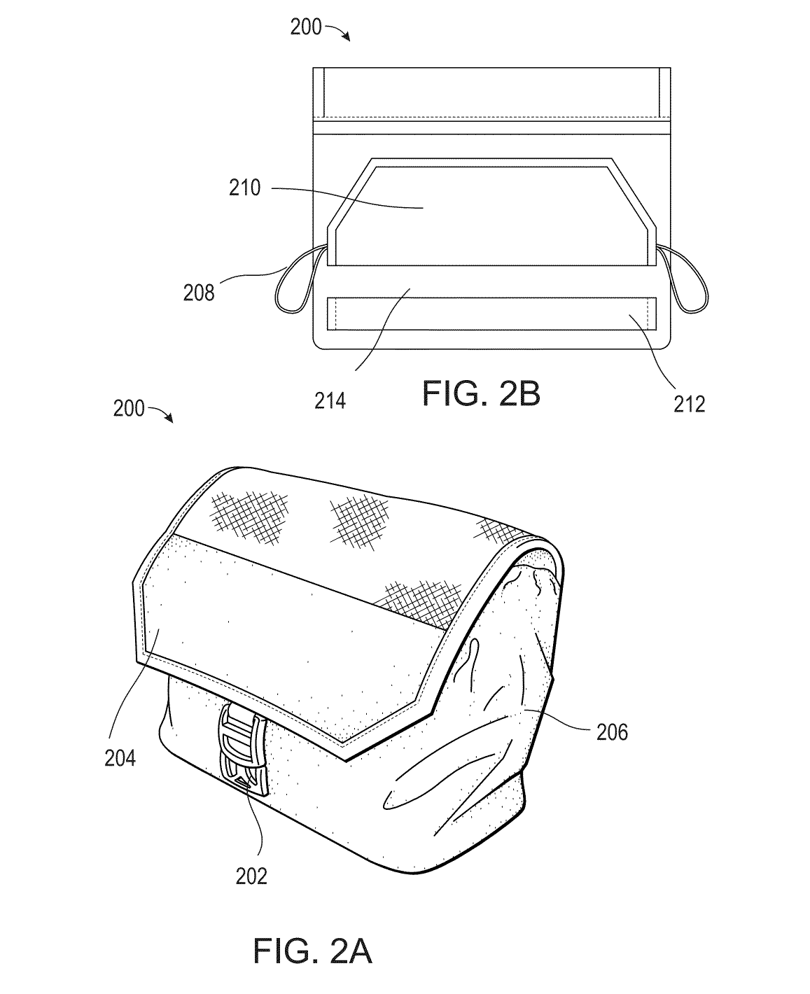

In furtherance of the desire to secure a removable bag to bracket 100, as shown in FIG. 1A, bag attachment portion 114 includes anchor components 116. The anchor components 116 may be used to assist in maintaining the bag (shown in FIGS. 2A and 2B) secured to the bracket 100. In some instances, anchor components 116 may be shaped with a hook shape, or a dual-sided hook shape such that the opposing hook shape portions extend in opposite directions of each other. More information regarding how the hook shape may be used in practice is described herein below. It is noted, however, that any shape of anchor component which permits a bag to be secured thereon may be used. Moreover, the anchor component 116 need not be a hook at all, but may also include snaps, hook-and-loop fabrics, etc. These are discussed below and further description of how the bag is attached is also included herein below.

In addition to the base 102 and the bag attachment portion 114, the bracket 100 may further include shims 108. On some recreational devices, a user might stand on the recreational device during use, such as a snowboard or a paddle board for example. Further, the bracket 100 may be attached to the device in a position where the user might stand on (above) the base 102 of the bracket 100. In this situation, base 102 may or may not be as long as a user's foot. Regardless, shims 108 may be placed next to the sides of the base 102 to extend the length of the base 102. In this manner, shims 108 may possibly provide additional stability and support to the toe and heel of a user's foot standing on base 102.

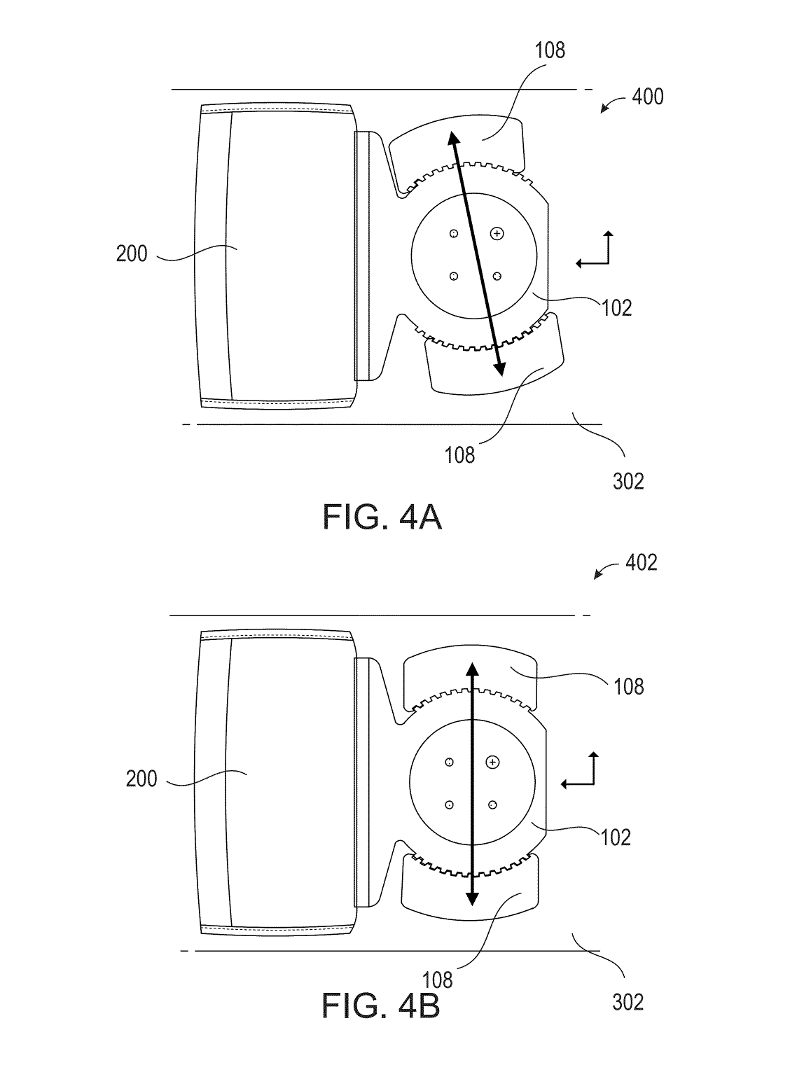

Another use for shims 108 is that they may be used to adjust and maintain the angle of the position of the foot placement on the recreational device. For example, in snowboarding, some snowboard users may desire to turn their foot so that it points at an angle to the board length direction, generally outward as shown in FIG. 4A, instead of keeping it pointing perpendicular to the board length direction, as shown in FIG. 4B. While the bracket 100 might be rotated entirely, it is possible that the rotation might cause the bag to hang off the board partially, which might interfere with turning on the snow. Thus, one way to assist in maintaining the foot at the desired position, rather than having to rotate the entire bracket 100, may be to rotate the position of shims 108 along the side of base 102 in opposite directions as shown in FIG. 4A. Shims 108 have teeth 110 that correspond to teeth 106 on base 102, and as such, shims 108 may assist in securing base 102 in the straight position, while still providing heel and toe support for the user's pivoted foot.

As depicted in FIG. 1A, the bag attachment portion 114 may also include holes 118. Holes 118 may be decorative as well as assist in weight reduction of bracket 100.

In another embodiment, as depicted in FIG. 1B, base 102 may include an accessory attachment anchor 120. It is noted that the connection portion at the distal end of the anchor 120 is merely a generically shaped end for attachment, and the depiction is not intended to be the sole type of attachment means. Rather, any number of connection types may be implemented to attach an accessory to the other side of base 102. For example, the connection type may be a buckle, a snap, a tether, or any other suitable means of attachment.

FIGS. 2A and 2B depict the isometric and rear views of a bag 200 that may be used with bracket 100. The particular type of bag and various types of pockets and latching mechanisms may be of any type. For example, a user may desire a waterproof or water-resistant bag, a bag that locks, a bag with a specialized camera compartment, a hard plastic/metal case bag, or any other suitable bag for the activity. The bag 200 is depicted with a latching mechanism 202, which is of the buckle type, however, any latching mechanism may be used if latching is desired. Bag 200 may also have a flap 204 to cover the pouch or pocket 206. The anchor component 208, however, should correspond in kind to the anchor component 116 of the bracket 100 so that the bag 200 can be attached properly. Thus, in an embodiment as depicted in FIG. 2B, the anchor component 208 is a loop type anchor to correspond with the hook-shaped anchor component 116 in FIG. 1A. Furthermore, bag 200 has other “anchoring” points or means including sleeve or pocket 210 and strip 212, which is separated from pocket 210 by a portion of the back of the bag 214.

In FIG. 3, an example of a bag assembly 300 shows an embodiment of how bag 200 may attach to bracket 100. Specifically, pocket 210 and strip 212 are slipped over the upper end of bag attachment portion 114 so that anchor components 116 are exposed. In this position, anchor components 208 may be looped around the hooks of exposed anchor components 116. Therefore, bag 200 may be secured to bracket 100. Further, a recreational board 302 is depicted to show how bag assembly 300 might be fastened to the board 302 via threaded bolt holes 304, into which bolts or screws 306 are inserted to secure a binding disc (not shown) through the hole 104 onto bracket 100, thereby sandwiching bracket 100 to the board 302. Though not depicted, in an embodiment of a snowboard, for example, a binding disc used to secure bracket 100 may have a diameter larger than D of through hole 104 so as to cover the inside edges of base 102 when bolted down.

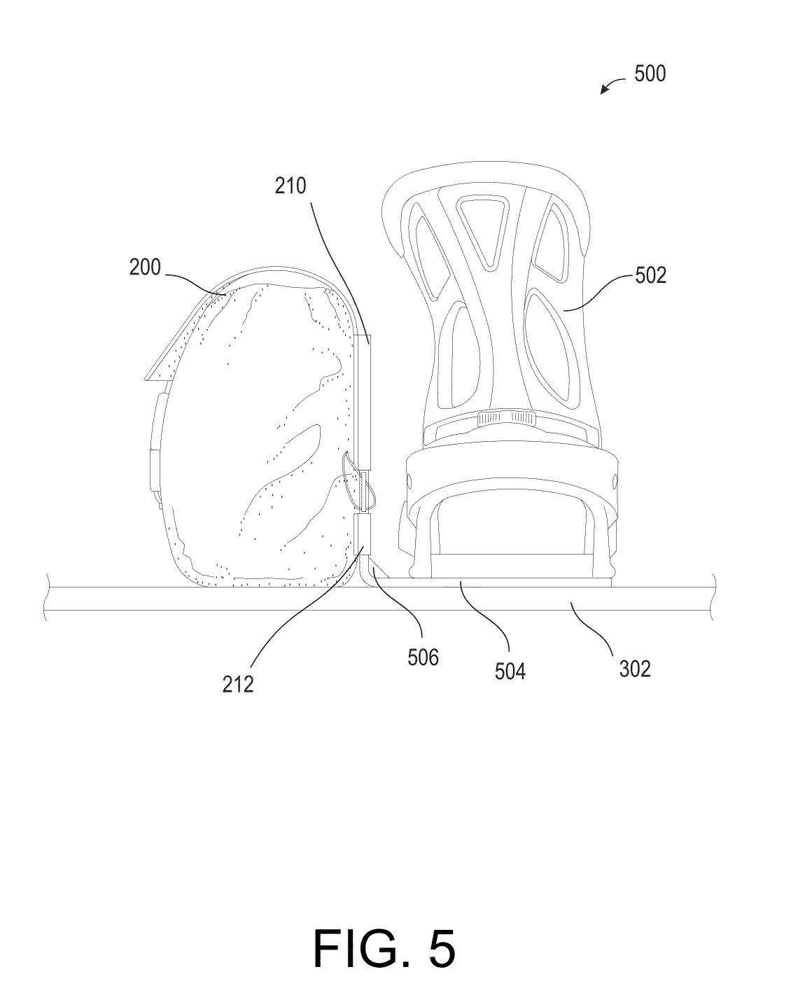

FIG. 5 depicts a side view of the bag assembly 300 in an embodiment with a snowboard 302. The assembly 500 further includes the binding boot 502, depicted as sitting on a bracket 504. It is noted that bracket 504 may further include one or more reinforcement ribs 506. Ribs 506 may extend across joint 112 of bracket 504, so as to reinforce the bend joint between base 102 and bag attachment portion 114. Moreover, ribs 506 may be dispersed along a width of the joint 112 between the base portion and the bag attachment portion. In some embodiments, ribs 506 are an integral part of bracket 504, and may be formed by pushing or molding the rib through the underside of bracket 504. Alternatively, ribs 506 may be added via welding or other attachment means after fabricating bracket 504.

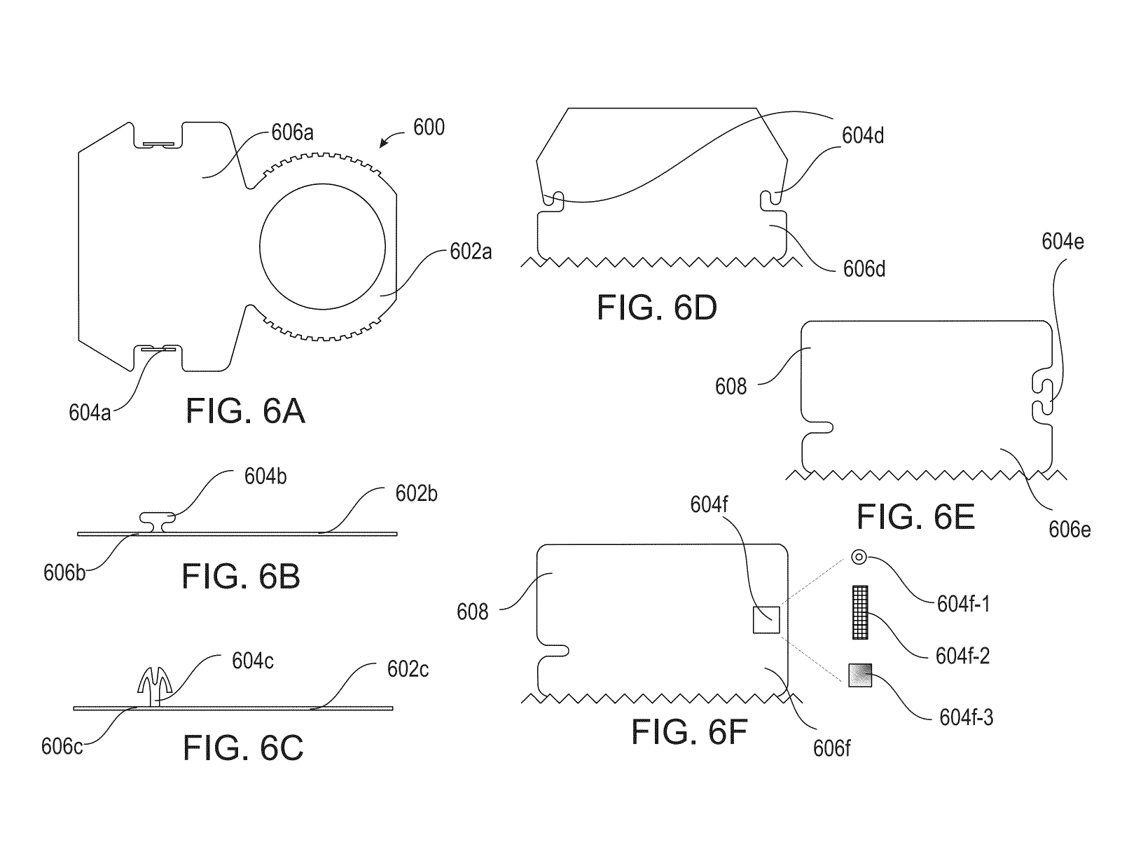

FIGS. 6A-6F depict various alternative embodiments of brackets 600. In particular, FIG. 6A shows a version of a bracket 600 having bag attachment portion 606a that extends in parallel with base 602a, instead of transverse to the direction of base 602a. Note, however, that the anchor components 604a are indicated as extending vertically, i.e., transverse to the direction of extension of base 602a so as to receive the anchor components of the bag 200. As such, in FIG. 6A, the bracket 600 is nearly flat with exception of the anchor components 604a. Thus, FIGS. 6B and 6C depict side profiles of alternative embodiments, showing a hook-shaped anchor component 604b in FIG. 6B and a buckle style anchor component 604c on respective bag attachment portions (606b, 606c) connected to respective bases (602b, 602c).

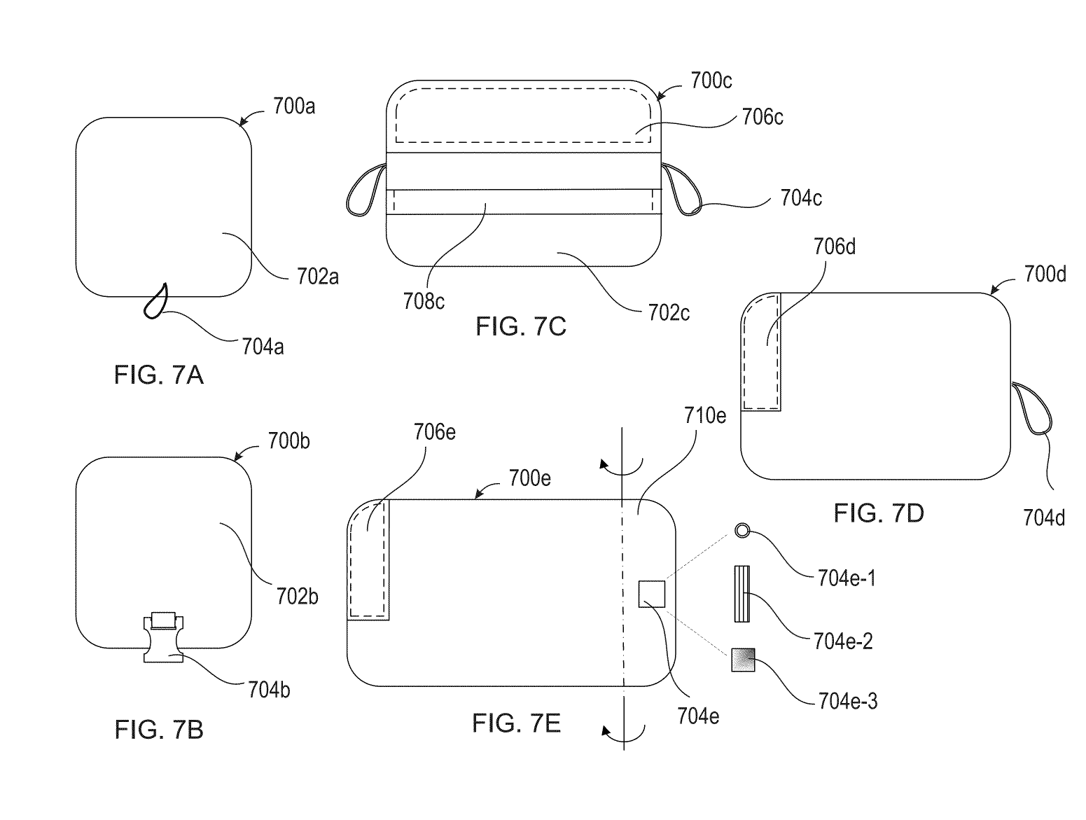

In FIGS. 6D-6F, only the bag attachment portions (606d, 606e, 606f) are shown for simplicity to depict alternative variations of anchor components (604d, 604e, 604f). Thus, in FIG. 6D, bag attachment portion 606d includes opposing single-hook shaped anchor components 604d. In FIGS. 6E and 6F, an alternative bag attachment portion 606e and 606f are shown. Specifically, instead of sliding a pocket of bag 200 over the top end of bag attachment portions, a sideways placed pocket (see FIGS. 7D, 7E) is slipped over a portion of a side 608 (left side in the figures) of bag attachment portions 606e, 606f. In FIG. 6E, a hook-shaped anchor component 604e is shown, on which a corresponding anchor element disposed at a side of a bag (see FIG. 7D) may be hooked. Alternatively, while bag attachment portion 606f in FIG. 6F may include a similar sideways bag pocket attachment means as in FIG. 6E, the anchor component 604f is depicted as any of three different potential types of anchors that are one part of two-part systems, including a snap button system 604f-1, a hook-and-loop fabric system 604f-2 (for example, Velcro™), and a magnetic system 604f-3.

It is noted that the magnetic system 604f-3 may be used in the place of the hook-shaped anchor component 604b in FIG. 6B and the buckle style anchor component 604c with the flat bracket shape as well. Further, the bag may incorporate the other half of the magnetic system 704e-3 in a corresponding location as shown in FIGS. 7A and 7B, or generally on a bottom of the bag 700a, 700b. For example, bag may magnetically attach to the base simply by setting the bag on the base, or sliding the bag into a locking position on the base with or without magnets. Additionally, a tether may be added on a side of the bag to anchor to a surface portion of the recreational device/board, as a secondary safety precaution.

Returning to complete the description of FIGS. 7A-7E, the various anchor components and bag attachment portions depicted in FIGS. 6B-6F may correspond to the various alternative embodiments of corresponding bags 700a-700e and corresponding anchor components 704a to 704e-3, respectively. Thus, the loop element anchor component 704a, located at a bottom of the bag 700a corresponds to the flattened embodiment of bracket 600 with hook-shaped anchor components 604b in FIG. 6B. Likewise, the buckle-type anchor component 704b, located at a bottom of the bag 700b corresponds to the flattened embodiment of bracket 600 with buckle-type anchor components 604c in FIG. 6C. The loop element anchor components 704c, located at the sides of the bag 700c correspond to the bag attachment portion 606d with single, hook-shaped anchor components 604d in FIG. 6D. The loop element anchor component 704d located at the side of the bag 700d (opposite the side pocket 706d, which slides onto side pocket portion 608) corresponds to the bag attachment portion 606e with hook-shaped anchor component 604e in FIG. 6E. With respect to FIG. 7E, however, it is noted that there is a flap of material 710e that extends beyond the length of the inner pocket of the bag 700e. As indicated by the pivot axis and arrows shown in FIG. 7E, the flap 710e may fold over the side of bag attachment portion 606f (opposite the side pocket portion 608, over which slides the side pocket 706e) to attach to the corresponding anchor component 604f. Note that any of the examples of the above mentioned two-part systems of anchor components 604f-1 to 604f-3 and 704e-1 to 704e-3 may be used, including the button system, the hook-and-loop fabric system, and the magnetic system. Further, the buttons, hook and loop elements, and magnets may all be located at various positions on the bag and bracket to conveniently carry one's belongings, and the depicted positions should not be viewed as the extent of possible locations.

Accordingly, a bag may be easily attached to a bracket for convenient storage while performing a recreational activity, as described herein.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. An apparatus, comprising:
a base that extends at least partially in a plane, a direction of a thickness of the base extending in a direction orthogonal to the plane, the base including an opening through the thickness thereof, such that the base is securable to a surface of an object via the opening;
a bag attachment portion extending from the base portion; and
an anchor member disposed on the bag attachment portion, the anchor member being configured to anchor a removable bag to the bag attachment portion when the base is secured to the object,
wherein at least one of the bag attachment portion or a portion of the anchor member extends in a direction transverse to the plane in which the base at least partially extends.

2. The apparatus according to claim 1, wherein the bag attachment portion extends in the direction transverse to the plane in which the base at least partially extends so as to form an L-shape profile with the base.

3. The apparatus according to claim 1, wherein the portion of the anchor member extends in the direction transverse to the plane in which the base at least partially extends.

4. The apparatus according to claim 1, wherein the anchor member is a first anchor member, and
wherein the apparatus further comprises a bag having a second anchor member that removably engages with the first anchor member such that the bag is removably attachable to the bag attachment portion.

5. The apparatus according to claim 1, further comprising a first shim disposed on a first side of the base and a second shim disposed on a second side of the base that is opposite the first side of the base,
wherein a position of the first and second shims is adjustable with respect to the base so as to assist in maintaining the base in a desired orientation with respect to the surface of the object.

6. The apparatus according to claim 5, wherein the first and second sides of the base include teeth that engage with correspondingly shaped teeth disposed on inner edges of the first and second shims so as to maintain the base in the desired orientation.

7. An apparatus, comprising:
a bracket including:
a base plate having a thickness direction that extends vertically, the base plate accommodating a fastening member to secure the bracket to a recreational board such that, in a fastened position, a surface of the base plate is secured against a surface of the board, and the surface of the base plate extending in a direction transverse to the thickness direction, and
a bag attachment portion that is integral with the base portion, the bag attachment portion including a first anchor member, the first anchor member being configured to removably engage with a second anchor member of a bag.

8. The apparatus according to claim 7, further comprising an accessory attachment anchor disposed on a side of the base plate, the accessory attachment anchor being configured to secure an accessory thereto.

9. The apparatus according to claim 7, wherein the first anchor member is integrally formed with the bag attachment portion, the first anchor member being shaped such that a portion of the first anchor member protrudes so as to form a hook shape.

10. The apparatus according to claim 9, further comprising the bag including the second anchor member, the second anchor member being a looped element, whereby the looped element removably engages the hook shaped portion of the second anchor member so as to connect the bag to the bracket.

11. The apparatus according to claim 8, wherein the first anchor member is a first element of a fastening system, a corresponding second element of the fastening system being the second anchor member of the bag,
wherein the two-element fastening system includes one of a snap button system, a hook-and-loop fastener system, a magnet system, and a buckle system.

12. The apparatus according to claim 7, further comprising the bag, which is removably attachable to the bracket via at least two anchoring points.

13. The apparatus according to claim 12, wherein the bag includes
a first piece of material forming a pocket on the bag, the pocket being on a first side of the bag and opening toward a center of the bag, and
a second piece of material connected at a second side of the bag, the second side being opposite the first side, and the second piece of material forming a flap such that when a first side of the bag attachment portion at a first anchoring point is slipped into the pocket, the flap of material folds over a second side of the bag attachment portion at a second anchoring point and connects with the bag attachment portion via engagement between the first anchor member and the second anchor member on the flap.

14. An apparatus, comprising:
a plate including:
a base portion having an opening through a thickness of the plate, the opening sized to accommodate fastening hardware of a recreational board therein such that the base is securable to a surface of the recreational board via the fastening hardware,
a bag attachment portion extending transverse to a direction of extension of the base portion, and
a first anchor member disposed on the bag attachment portion;
a bag including a second anchor member that is removably engageable with the bag attachment portion when the bag is placed against the bag attachment portion.

15. The apparatus according to claim 14, further comprising one or more reinforcement ribs extending and dispersed across a width of an intersection between the base portion and the bag attachment portion,
wherein the ribs are an integral part of the plate.

16. The apparatus according to claim 14, wherein the first anchor member includes a portion having a hook shape that extends toward the base portion, and
wherein the second anchor member includes a loop element on a side of the bag such that the loop element is removably attachable to the hook-shaped portion of the first anchor member.

17. The apparatus according to claim 14, wherein the bag includes a pocket sized to accommodate an insertion part of the bag attachment portion therein,
wherein, when the bag is attached, the insertion part of the bag attachment portion is inserted into the pocket of the bag such that the first anchor member remains exposed, and
wherein the second anchor member is connected to the first anchor member.

18. The apparatus according to claim 14, wherein the bag includes a material strip connected to the bag on opposite ends thereof and spaced apart from the pocket such that, when the bag is attached, the insertion part of the bag attachment portion is inserted through the material strip such that the first anchor member remains exposed between the pocket and the material strip.

19. The apparatus according to claim 14, further comprising shims that are disposed along lateral sides of the base portion, the shims having a same thickness as the thickness of the plate.

20. The apparatus according to claim 14, further comprising:
a snowboard binding; and
a snowboard, which is the recreational board,
wherein the plate is secured to the surface of the snowboard via the fastening hardware, which simultaneously fastens the snowboard binding to an upper surface of the base portion of the plate.
